(19) United States
(12) Patent Application Publication
(10) Pub. No.: US 2015/0248748 A1
(43) Pub. Date: Sep. 3, 2015

(54) METHOD AND APPARATUS TO DETERMINE A MEDIAN PIXEL VALUE

(71) Applicant: QUALCOMM Incorporated, San Diego, CA (US)

(72) Inventors: Adarsh Hosaagrahara Nagaraja, San Diego, CA (US); Weiliang Liu, San Diego, CA (US)

(73) Assignee: QUALCOMM Incorporated, San Diego, CA (US)

(21) Appl. No.: 14/194,436

(22) Filed: Feb. 28, 2014

(51) Int. Cl. G06T 5/10; G06T 5/00

(52) U.S. Cl. CPC G06T 5/10; G06T 5/002; G06T 2207/20032

(57) ABSTRACT

A method includes selecting, at an image processor, a filtering network from a plurality of available filtering networks. The method also includes inserting a set of pixel values into an array and inserting at least one padding pixel value into the array. The method further includes applying the selected filtering network to the array to determine a median pixel value of the set of pixel values.

### I. FIELD

The present disclosure is generally related to determining a median pixel value.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Cameras within wireless telephones (e.g., a digital still camera or a digital video camera) may capture images, and image processors within the wireless telephone may use median filtering techniques to adjust color and/or intensity of pixels in the captured images (e.g., correct pixels in the captured images). For example, an image may include an area having substantially constant pixel values (e.g., color values), and a particular pixel (e.g., an outlier) having a dissimilar value may appear in the area. The particular pixel may appear as a “spot” in the image. Image processors may perform median filtering on the particular pixel to change the pixel value based on surrounding pixel values. However, conventional image processors may perform median filtering on each pixel in the image, which may be time-consuming and may reduce image quality.

Further, image processors may use sorting networks (e.g., algorithms) to select a median pixel value of a kernel (e.g., a rectangular matrix of pixels that includes the pixel on which median filtering is performed). However, typical sorting networks may be structured to operate on kernels having designated pixel dimensions. For example, sorting networks may be available for 3-pixel kernels, 5-pixel kernels, 7-pixel kernels, 9-pixel kernels, and 25-pixel kernels. For these kernel sizes, the corresponding sorting networks may determine a median value in fewer operations than “brute force” median computation. However, determining a median pixel value for a kernel having a different number of pixels (e.g., a 15-pixel kernel) results in additional instructions and increased processing times (e.g., due to use of a “brute force” method).

### III. SUMMARY

Systems and methods to determine a median pixel value are disclosed, including determining a median pixel value for kernel sizes for which a sorting network is not available. An image processor may select particular pixels (e.g., outliers) at various locations of an image to perform median filtering operations. For example, the image processor may select a first outlier pixel and a second outlier pixel that is not adjacent to (e.g., discontinuous from) the first outlier pixel. The image processor may use a “fast” method (e.g., a sorting network based median calculation) to perform median filtering on outlier pixels at various locations in the image plane.

In accordance with the described techniques, the image processor may execute instructions based on a sorting network structured for a particular kernel size and/or particular kernel shape (e.g., rectangular) even though an input kernel has a different kernel size and/or a different kernel shape. For example, sorting networks may be available for 3-pixel kernels, 5-pixel kernels, 7-pixel kernels, 9-pixel kernels, and 25-pixel kernels. The kernels may have varying shapes. For example, the kernels may be square kernels, rectangular kernels, five-sided kernels, etc. To determine a median pixel value of pixels in a different-sized kernel (e.g., a 15-pixel kernel), the image processor may use a sorting network having a next highest dimension (e.g., the 25-pixel kernel) and “pad” the kernel with low pixel values (e.g., “0”) and high pixel values (e.g., “255”) so as to not change the median pixel value. The image processor may insert the 15 pixel values (in the 15-pixel kernel) into an array configured to store 25 pixel values. The image processor may pad five of the remaining 10 storage areas of the array with a “0” value and pad the remaining five storage areas of the array with a “255” value.

As an illustrative non-limiting example, the sorting network may use a Compare and Exchange (CEX) algorithm and the image processor may execute 99 CEX instructions to determine the median pixel value of the 25 pixels values (including the padded pixels) in the array. The image processor may reduce processing time and complexity by removing redundant instructions (e.g., removing instructions that compare “0” pixel values with “255” pixel values). As a result, less than 99 CEX instructions may be executed to determine the median pixel value. The image processor may utilize single-instruction-multiple-data (SIMD) processing to determine multiple median pixel values. For example, the image processor may determine 8 or 16 unique discontinuous locations for which a median filter operation is to be performed. The image processor may arrange the pixel data of these 8 or 16 locations and may execute CEX instructions using a SIMD architecture to produce median values of the 8 or 16 pixels in parallel.

In a particular embodiment, a method includes selecting, at an image processor, a filtering network from a plurality of available filtering networks. The method also includes inserting a set of pixel values into an array and inserting at least one padding pixel value into the array. The method further includes applying the selected filtering network to the array to determine a median pixel value of the set of pixel values.

In another particular embodiment, an apparatus includes a memory and an image processor coupled to the memory. The image processor is configured to select a filtering network from a plurality of available filtering networks. The image processor is also configured to insert a set of pixel values into an array and to insert at least one padding pixel value into the array. The image processor is further configured to apply the selected filtering network to the array to determine a median pixel value of the set of pixel values.

In another particular embodiment, an apparatus includes means for selecting a filtering network from a plurality of available filtering networks. The apparatus also includes means for inserting a set of pixel values into an array and means for inserting at least one padding pixel value into the array. The apparatus further includes means for applying the selected filtering network to the array to determine a median pixel value of the set of pixel values.

In another particular embodiment, a non-transitory computer-readable medium includes instructions that, when executed by an image processor, cause the image processor to select a filtering network from a plurality of available filtering networks. The instructions are also executable to cause the image processor to insert a set of pixel values into an array and to insert at least one padding pixel value into the array. The instructions are further executable to cause the image processor to apply the selected filtering network to the array to determine a median pixel value of the set of pixel values.

Filtering kernels may have different shapes. For example, a first filtering kernel may have a first shape (e.g., a rectangle, square, etc.) and a first kernel size, and a second filtering kernel may have a different shape and a second kernel size that is larger than the first kernel size. A sorting network may be available to determine a median pixel value of the second kernel size. Pixel values in the first filtering kernel may be added to an array having the second kernel size. The array may be padded with high pixel values and low pixel values, and the sorting network may be applied to the array to determine the median pixel value of the pixels in the first filtering kernel. Thus, multiple filtering kernel shapes may be used (as opposed to only rectangular filtering kernel shapes), because the pixel values are inserted into an array, and the sorting network applied to the array is dependent on the array size (corresponding to the size of the filtering kernel) and is independent of the filtering kernel shape.

In another particular embodiment, a method includes inserting, at an image processor, a set of pixel values corresponding to a first filtering kernel having a first shape into a second filtering kernel having a second shape. The method also includes inserting at least one padding pixel value into the second filtering kernel. The method further includes determining, based on the second filtering kernel, a median pixel value of the set of pixel values corresponding to the first filtering kernel.

In another particular embodiment, an apparatus includes a memory and an image processor coupled to the memory. The image processor is configured to insert a set of pixel values corresponding to a first filtering kernel having a first shape into a second filtering kernel having a second shape. The image processor is also configured to insert at least one padding pixel value into the second filtering kernel. The image processor is further configured to determine, based on the second filtering kernel, a median pixel value of the set of pixel values corresponding to the first filtering kernel.

In another particular embodiment, an apparatus includes means for inserting a set of pixel values corresponding to a first filtering kernel having a first shape into a second filtering kernel having a second shape. The apparatus also includes means for inserting at least one padding pixel value into the second filtering kernel. The apparatus further includes means for determining, based on the second filtering kernel, a median pixel value of the set of pixel values corresponding to the first filtering kernel.

In another particular embodiment, a non-transitory computer-readable medium includes instructions that, when executed by an image processor, cause the image processor to insert a set of pixel values corresponding to a first filtering kernel having a first shape into a second filtering kernel having a second shape. The instructions are also executable to cause the image processor to insert at least one padding pixel value into the second filtering kernel. The instructions are further executable to cause the image processor to determine, based on the second filtering kernel, a median pixel value of the set of pixel values corresponding to the first filtering kernel.

One particular advantage provided by at least one of the disclosed embodiments is an ability to determine a median pixel value associated with a kernel of arbitrary shape or size. Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a diagram of a particular illustrative embodiment of a system that is operable to determine a median pixel value;

FIG. 2 is a diagram of a processing system that is operable to determine a median pixel value in a color image;

FIG. 3 is a flowchart of a particular embodiment of a method of determining a median pixel value;

FIG. 4 is a flowchart of another particular embodiment of a method of determining a median pixel value; and

FIG. 5 is a block diagram of a wireless device including components that are operable to determine a median pixel value.

### V. DETAILED DESCRIPTION

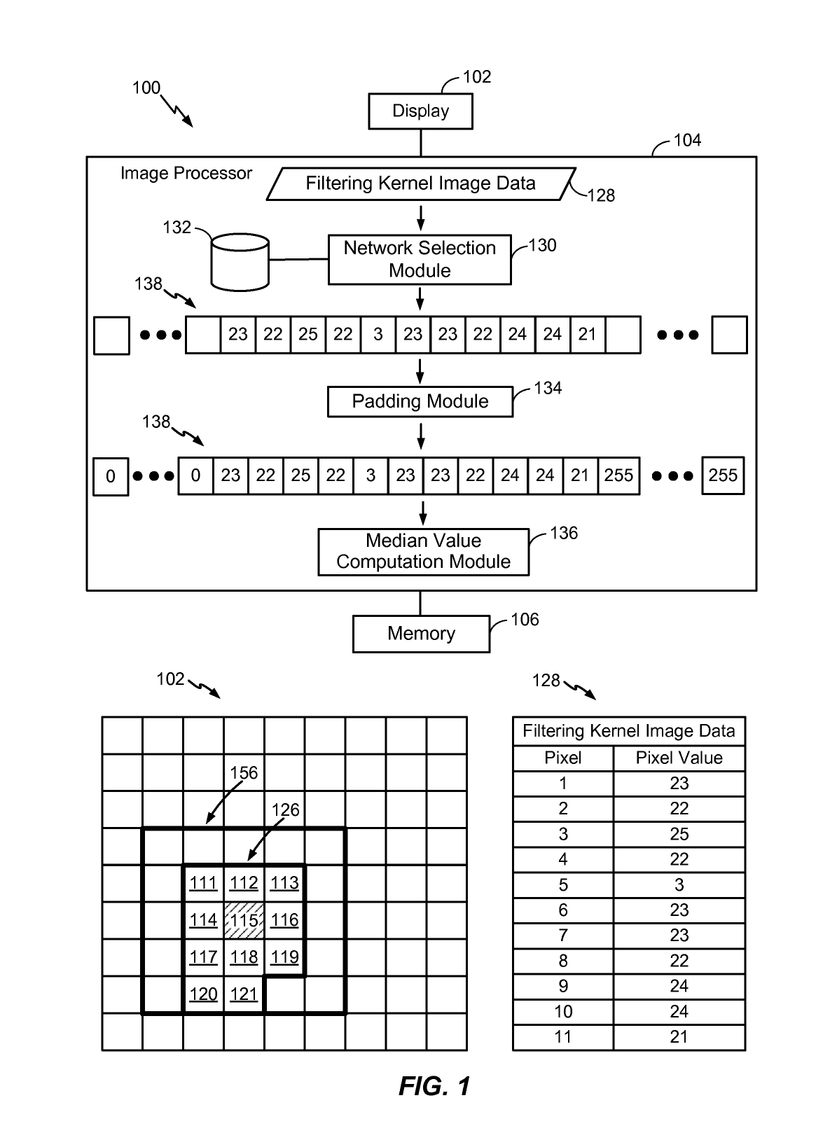

Referring to FIG. 1, a particular illustrative embodiment of a system 100 that is operable to determine a median pixel value is shown. The system 100 includes a display 102, an image processor 104, and a memory 106. The display 102 may be coupled to the image processor 104 such that the image processor 104 may generate image data based on images associated with the display 102. The memory 106 may also be coupled to the image processor 104. The image processor 104 may include a network selection module 130, a padding module 134, and a median value computation module 136 to perform median filtering.

The display 102 may depict an image. In the embodiment illustrated in FIG. 1, the display 102 includes 81 pixels (e.g., 9-pixels×9-pixels). However, the pixel dimension of the display 102 is for illustrative purposes only and should not be construed as limiting. In alternative embodiments, the display 102 may be a 20 megapixel display, a 15 megapixel display, etc.

Each pixel in the image may have a particular color and/or a particular intensity. For example, if the image corresponds to a color image, each pixel may have a red-difference chroma pixel value associated with a red channel of the pixel, a green-difference chroma pixel value associated with a green channel of the pixel, and a blue-difference chroma pixel value associated with a blue channel of the pixel. In a 24-bit color image, each chroma pixel value may correspond to an integer value between “0” and “255.” For example, a pixel having a red-difference chroma pixel value of “82” may have a different depth of red than a pixel having a red-difference chroma pixel value of “233.” In a similar manner, a pixel having a green-difference chroma pixel value of “132” may have a different depth of green than a pixel having a green-difference pixel chroma value of “29,” etc. Thus, multiple colors may be represented based on the combination of chroma pixel values for each channel.

If the image corresponds to an 8-bit grayscale image, each pixel may have one of 256 intensities (e.g., hue values/pixel values). For example, a “black” pixel may have a hue value of “0” and a “white” pixel may have a hue value of “255.” The hue value increases as a pixel approaches white.

The pixel values (e.g., color values, hue values, etc.) of each pixel in the display 102 may be generated by the image processor 104 as image data. Based on the pixel values, the image processor 104 may be configured to select outlier pixels at discontinuous locations of the image and to perform median filtering operations to correct the outlier pixels. An outlier pixel may correspond to a pixel that has a pixel value that is greater than (or less than) each of its surrounding pixels by a particular threshold. An outlier pixel may correspond to noise (e.g., spot noise, chroma noise, low light noise, etc.) in the image and/or artifacts (line segments, text, etc.) in the image.

As an illustrative example, the image processor 104 may apply a filtering kernel 126 to a selected portion of the image in the display 102. The filtering kernel 126 may have an arbitrary format (e.g., shape and size). In the illustrated embodiment, the filtering kernel 126 is a 6 sided polygon that includes 11 pixels (e.g., a first pixel 111, a second pixel 112, a third pixel 113, a fourth pixel 114, a fifth pixel 115, a sixth pixel 116, a seventh pixel 117, an eighth pixel 118, a ninth pixel 119, a tenth pixel 120, and an eleventh pixel 121).

The image processor 104 may generate filtering kernel image data 128 (e.g., a set of pixels values) for the pixels in the filtering kernel 126. For example, the first pixel 111 may have a pixel value of “23,” the second pixel 122 may have a pixel value of “22,” the third pixel 113 may have a pixel value of “25,” the fourth pixel 114 may have a pixel value of “22,” the fifth pixel 115 may have a pixel value of “3,” the sixth pixel 116 may have a pixel value of “23,” the seventh pixel 117 may have a pixel value of “23,” the eighth pixel 118 may have a pixel value of “22,” the ninth pixel 119 may have a pixel value of “24,” the tenth pixel 120 may have a pixel value of “24,” and the eleventh pixel 121 may have a pixel value of “21.”

The image processor 104 may determine that the fifth pixel 115 is an outlier pixel. In response to determining that the fifth pixel 115 is an outlier pixel, the image processor 104 may be configured to perform median filtering on the area surrounding the fifth pixel 115 using the filtering kernel image data 128.

The network selection module 130 may select a filtering network (e.g., a sorting network) from a plurality of available filtering networks based on a number of pixels (e.g., the number of pixel values) in the filtering kernel image data 128. For example, the network selection module 130 may be coupled to a database 132 that stores the plurality of available filtering networks. Although depicted inside the image processor 104, the database 132 may be external to the image processor 104. Each filtering network of the plurality of available filtering networks may be configured to determine a median pixel value for a particular number of pixels values using a particular algorithm. For example, a 3-pixel filtering network may be configured to determine a median pixel value for 3 pixel values, a 5-pixel filtering network may be configured to determine a median pixel value for 5 pixel values, a 7-pixel filtering network may be configured to determine a median pixel value for 7 pixel values, a 9-pixel filtering network may be configured to determine a median pixel value for 9 pixel values, a 25-pixel filtering network may be configured to determine a median pixel value for 25 pixel values, etc. In a particular embodiment, the filtering networks may utilize a compare and exchange (CEX) median filtering algorithm. However, it will be appreciated that other algorithms designed to determine a median pixel value may be used.

In response to a determination that the database 132 does not include a filtering network having dimensions that match the number of pixel values in the filtering kernel image data 128 (e.g., in response to a determination that the database 132 does not include a filtering network for 11 pixel values), the network selection module 130 may select an available filtering network having a next highest dimension. Thus, in the illustrative embodiment, the network selection module 130 may select the 25-pixel filtering network configured to determine the median pixel value for 25 pixel values. Therefore, the set of pixel values in the filtering kernel image data 128 may include a number of pixel values (e.g., 11 pixel values) that is between the number of pixel values supported by the selected kernel (e.g., 25 pixel values) of the selected filtering network (e.g., the 25-pixel filtering network) and the next lower number of pixel values (e.g., 9 pixel values) associated with one of the remaining filtering networks (e.g., the 9-pixel filtering network).

The image processor 104 may be configured to insert the set of pixel values into an array 138 (e.g., one or more registers) that is associated with the selected filtering network. For example, the array 138 may include 25 data slots, and the image processor 104 may insert the 11 pixel values into the array 138. The padding module 134 may be configured to insert at least one padding pixel value into the array 138. For example, the padding module 134 may insert low pixel value(s) (e.g., “0”) and high pixel value(s) (e.g., “255”) into the remaining data slots of the array 138. The same number of low and high values may be inserted so as to not change the median pixel value in the array 138.

The median value computation module 136 may be configured to apply the selected filtering network to the array 138 to determine a median pixel value of the set of pixel values (e.g., the filtering kernel image data 128). For example, the median value computation module 136 may apply the 25-pixel filtering network to the array 138 to determine the median pixel value of the set of pixel values.

Determining the median pixel value may include executing multiple CEX instructions according to a selected filtering network. As a non-limiting illustrative example, 99 CEX instructions may be executed by the image processor 104 according to the 25-pixel filtering network to determine a median pixel value of the pixel values in the array 138. In a particular embodiment, the image processor 104 may reduce the processing time associated with determining the median pixel value by not executing (e.g., skipping) CEX instructions that compare a padded pixel value to another padded pixel value. For example, in the illustrative embodiment, the image processor 104 may remove CEX instructions that compare a pixel value of “0” to a pixel value of “0,” remove CEX instructions that compare a pixel value of “0” to a pixel value of “255,” and remove CEX instructions that compare a pixel value of “255” to a pixel value of “255.” In a particular embodiment, 48 CEX instructions may be removed to decrease processing time.

Thus, the median value computation module 136 may execute CEX instructions to determine the median pixel value of the pixels in the filtering kernel 126. In the illustrative embodiment, the median pixel value is “23.” The image processor 104 may change the value of the outlier pixel (e.g., the fifth pixel 115) to the median pixel value as part of a noise-reduction or artifact-reduction operation. In the illustrative embodiment, the image processor 104 may change the pixel value of the fifth pixel 115 to “23.”

In a particular embodiment, an odd number of padding values are inserted into the array 138. For example, the padding module 134 may insert one more high padding pixel value than low padding pixel value into the remaining data slots of the array 138. As a non-limiting example, if 12 pixel values associated with a kernel were inserted into the array 138, the padding module 134 may insert six low padding pixel values and seven high padding pixel values into the remaining data slots of the 25-slot array 138. Alternatively, the padding module 134 may insert one more low padding pixel value than high padding pixel value into the remaining data slots of the array 138. For example, the padding module 134 may insert seven low padding pixel values and six high padding pixel values into the remaining data slots of the 25-slot array 138. When an odd number of padding values are inserted and/or when the input kernel has an even number of pixels, the median value computation module 136 may determine a median pixel value corresponding to a midpoint (e.g., average) of two “middle” pixel values.

The system 100 of FIG. 1 may remove noise and/or artifacts in an image by selecting outlier pixels in the image and performing median filtering operations to correct (e.g., change) pixel values associated with the outlier pixels. Median filter processing time may be decreased by padding the array 138 to generate a number of pixel values associated with an available filtering network (instead of attempting to create a new filtering network for an arbitrary array size) and removing redundant CEX instructions that compare the padded pixel values. The image processor 104 may also utilize single-instruction-multiple data (SIMD) to simultaneously determine multiple median pixel values to remove noise and/or artifacts at multiple locations in the image. For example, the image processor 104 may locate 8 or 16 unique discontinuous locations (e.g., pixels) for median filtering processing. The image processor 104 may arrange the data of these locations and may execute CEX instructions on a SIMD architecture to generate 8 or 16 median pixel values simultaneously. In one embodiment, processing time may be reduced by as much as 40 percent compared to the processing time associated with determining the median pixel value using a conventional method. The techniques described with respect to the system 100 may thus be used to enhance computer applications (e.g., computer vision, image processing, etc.) that involve noise reduction or artifact reduction.

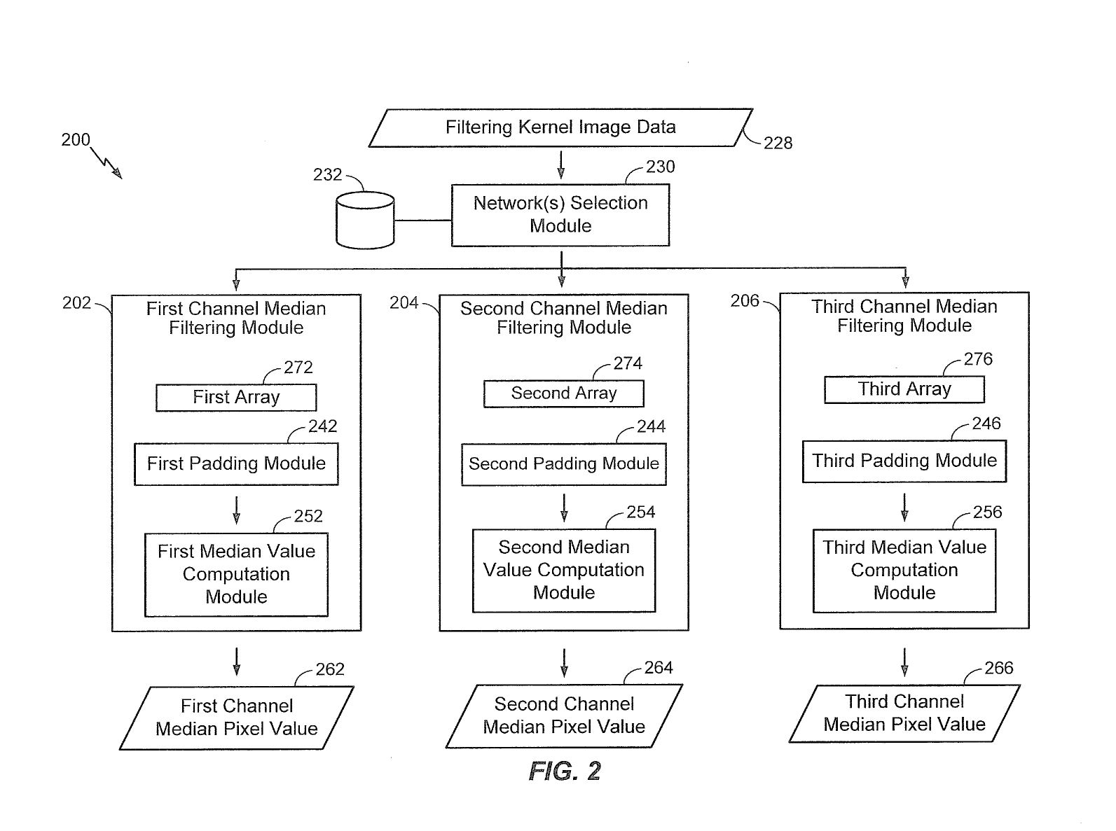

Referring to FIG. 2, a diagram of a processing system 200 that is operable to determine a median pixel value in a color image is shown. The processing system 200 may correspond to the image processor 104 of FIG. 1. The processing system 200 includes one or more network selection modules 230, a first channel median filtering module 202, a second channel median filtering module 204, and a third channel median filtering module 206. The first channel median filtering module 202 may be associated with a red-difference chroma values, the second channel median filtering module 204 may be associated with green-difference chroma values, and the third channel median filtering module 206 may be associated with blue-difference chroma values.

In a particular embodiment, the processing system 200 may generate red-difference chroma values, green-difference chroma values, and blue-difference chroma values for a common set of pixels. For example, the processing system 200 may generate red-difference chroma values, green-difference chroma values, and blue-difference chroma values for each pixel 111-121 (e.g., 11 pixels) in the filtering kernel 126 of FIG. 1. The red-difference chroma values for each pixel 111-121 may be inserted into a first array 272 in the first channel median filtering module 202, the green-difference chroma values for each pixel 111-121 may be inserted into a second array 274 in the second channel median filtering module 204, and the blue-difference chroma values for each pixel 111-121 may be inserted into a third array 276 in the third channel median filtering module 206.

A first padding module 242 may insert one or more padding pixel values (e.g., low pixel values and high pixel values) into the first array 272, a second padding module 244 may insert one or more padding pixel values into the second array 274, and a third padding module 246 may insert one or more padding values into the third array 276. A first median value computation module 252 may apply the filtering network selected by the network selection module 230 to the first array 272 to determine a first channel median pixel value 262 (e.g., a median value of the red-difference chroma values), a second median value computation module 254 may apply the selected filtering network to the second array 274 to determine a second channel median pixel value 264 (e.g., a median value of the green-difference chroma values), and a third median value computation module 256 may apply the 25-pixel filtering network to the third array 276 to determine a third channel median pixel value 266 (e.g., a median value of the blue-difference chroma values). The median pixel values 262-266 may be determined in parallel.

The processing system 200 may change the red-difference chroma value of an outlier pixel (e.g., the pixel 115 of FIG. 1) to the first channel median pixel value 262, change the green-difference chroma value of the outlier pixel to the second channel median pixel value 264, and change the blue-difference chroma value of the outlier pixel to the third channel median pixel value 266.

In another particular embodiment, the processing system 200 generates red-difference chroma values for a first set of pixels, green-difference chroma values for a second set of pixels, and blue-difference chroma values for a third set of pixels. Each set of pixels may include a common outlier pixel (e.g., the pixel 115). As a non-limiting example, the first set of pixels may correspond to the pixels 111-121 in the filtering kernel 126, the second set of pixels may include 15 pixels in a second filtering kernel that includes the outlier pixel, and the third set of pixels may include 19 pixels in a third filtering kernel that includes the outlier pixel.

Because each set of pixels includes more than 9 pixels and less than twenty-six 26 pixels, the network selection module 230 may select the 25-pixel filtering network from the database 232 storing the plurality of available filtering networks. Each set of pixels may be inserted into an array in the corresponding channel median filtering module 202-206, and the padding modules 242-246 may insert one or more padding pixel values to the arrays. For example, the first padding module 242 may insert 14 padding pixel values (e.g., seven low padding pixel values and seven high padding pixel values), the second padding module 244 may insert ten padding pixel values, and the third padding module 246 may insert six padding pixel values.

The median value computation modules 252-256 may apply the selected filtering network to the corresponding arrays 272-276 to generate the first channel median pixel value 262 based on the first set of pixels, the second channel median pixel value 264 based on the second set of pixels, and the third channel median pixel value 266 based on the third set of pixels. The processing system 200 may change the red-difference chroma value of the outlier pixel (e.g., the pixel 115) to the first channel median pixel value 262, change the green-difference chroma value of the outlier pixel to the second channel median pixel value 264, and change the blue-difference chroma value of the outlier pixel to the third channel median pixel value 266.

However, in the scenario that at least one set of pixels had less than 10 pixels or more than 25 pixels, the network selection module 230 would select a different filtering network for that particular set of pixels. For example, in response to determination that the second set of pixels included 8 pixels, the network selection module 230 would select the 9-pixel filtering network (e.g., the filtering network configured to determine the median pixel value for 9 pixel values) from the database 232. The second set of pixels would be provided to an array in the second channel median filtering module 204, and the second padding module 244 would pad the array with a single pixel value. The second median value computation module 252 would apply the 9-pixel filtering network to the array to determine the second channel median pixel value 264.

The processing system 200 of FIG. 2 may remove noise and/or artifacts in an image by selecting outlier pixels in the image and performing median filtering operations on a channel-by-channel basis to correct (e.g., change) pixel values associated with the outlier pixels. Median filter processing time may be decreased by padding the arrays in the channel median filtering modules 202-206 to generate a number of pixel values associated with an available filtering network and removing redundant CEX instructions that compare the padded pixel values. The image processor 104 may also utilize a single-instruction-multiple data (SIMD) processor to simultaneously determine multiple median pixel values to remove noise and/or artifacts at multiple locations in the image. The techniques described with respect to the system 200 may also be used to enhance computer applications (e.g., computer vision, image processing, etc.) associated with the image. In alternate embodiments, additional (or fewer) parallel median filtering modules may be used. If the image is a grayscale image, each module may perform median filtering for a different outlier pixel in parallel.

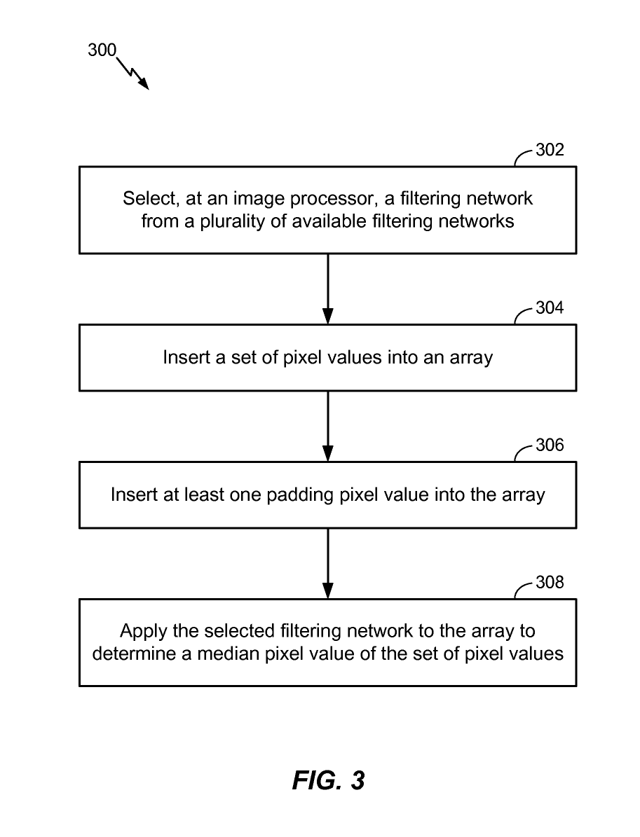

Referring to FIG. 3, a flowchart of a particular embodiment of a method 300 of determining a median pixel value is shown. In an illustrative embodiment, the method 300 may be performed using the system 100 of FIG. 1 or the processing system 200 of FIG. 2.

The method 300 includes selecting, at an image processor, a filtering network from a plurality of available filtering networks, at 302. For example, referring to FIG. 1, the network selection module 130 may select a filtering network from the database 132 based on there being 11 pixels (e.g., the 11 pixel values) in the filtering kernel image data 128. In response to a determination that the database 132 does not include a filtering network for exactly 11 pixel values, the network selection module 130 may select the filtering network having a next highest dimension, i.e., the 25-pixel filtering network.

A set of pixel values may be inserted into an array, at 304. For example, referring to FIG. 1, the image processor 104 may insert the 11 pixel values into 11 of the 25 locations of the array 138. At least one padding pixel value may be inserted into the array, at 306. For example, the padding module 134 may insert low pixel values (e.g., “0”) and high pixel values (e.g., “255”) into the 14 remaining data slots of the array 138.

The selected filtering network may be applied to the array to determine a median pixel value of the set of pixel values, at 308. For example, referring to FIG. 1, the median value computation module 136 may apply the selected filtering network to the array 138 to determine a median pixel value of the set of pixel values. Determining the median pixel value may include executing multiple CEX instructions according to the 25-pixel filtering network. As a non-limiting illustrative example, 99 CEX instructions may be executed by the image processor 104 to determine a median pixel value of the 25 pixel values in the array 138. The image processor 104 may reduce the processing time associated with determining the median pixel value by removing CEX instructions that compare a padded pixel value to another padded pixel value.

In a particular embodiment, the method 300 may include inserting a second set of pixels values into a second array. For example, referring to FIG. 2, the first set of pixel values (e.g., red-difference chroma values) may be inserted into the first array 272 in the first channel median filtering module 202, and the second set of pixel values (e.g., green-difference chroma values) may be inserted into the second array 274 in the second channel median filtering module 204. At least one pixel value of the first set of pixel values and at least one pixel value of the second set of pixel values may represent a common pixel. For example, the red-difference chroma value of the fifth pixel 115 and the green-difference chroma value of the pixel 115 may represent a common pixel.

In a particular embodiment, the method 300 may also include inserting at least one padding pixel value into the second array. For example, referring to FIG. 2, the first padding module 242 may insert one or more padding pixel values (e.g., low pixel values and high pixel values) into the first array 272, and the second padding module 244 may insert one or more padding pixel values into the second array 274.

In a particular embodiment, the method 300 may also include applying the selected filtering network to the second array to determine a second median pixel value of the second set of pixel values. For example, referring to FIG. 2, the first median value computation module 252 may apply the 25-pixel filtering network to the first array 272 to determine the first channel median pixel value 262 (e.g., a median value of the red-difference chroma values), and the second median value computation module 254 may apply the 25-pixel filtering network to the second array 274 to determine a second channel median pixel value 264 (e.g., a median value of the green-difference chroma values). The first channel median pixel value 262 and the second channel median pixel value 264 may be determined in parallel. For example, the first channel median filtering module 202 may determine the first channel median pixel value 262 while the second channel median filtering module 204 determines the second channel median pixel value 264.

The method 300 of FIG. 3 may remove noise and/or artifacts in an image by selecting outlier pixels in the image and performing median filtering operations to correct (e.g., change) pixel values associated with the outlier pixels. Median filter processing time may be decreased by padding the array to generate a number of pixel values associated with the selected filtering network and removing redundant CEX instructions that compare the padded pixel values. The image processor 104 may also utilize a single-instruction-multiple data (SIMD) processor to simultaneously determine multiple median pixel values to remove noise and/or artifacts at multiple locations in the image.

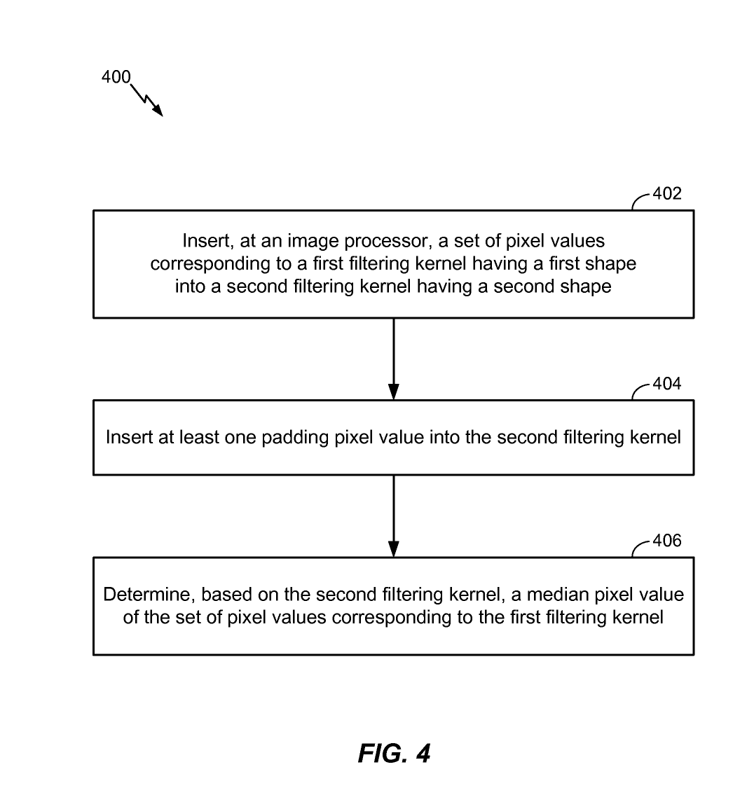

Referring to FIG. 4, a flowchart of another particular embodiment of a method 400 of determining a median pixel value is shown. In an illustrative embodiment, the method 400 may be performed using the system 100 of FIG. 1 or the processing system 200 of FIG. 2.

The method 400 includes inserting, at an image processor, a set of pixel values corresponding to a first filtering kernel having a first shape into a second filtering kernel having a second shape, at 402. For example, referring to FIG. 1, the image processor 104 may insert the set of pixel in the filtering kernel 126 (e.g., the first filtering kernel) having a first shape into a second filtering kernel 156 (e.g., a 25-pixel filtering kernel) having a second shape. In FIG. 1, the first shape is six-sided and the second shape is a rectangle. However, it should be noted that these shapes are used for illustrative purposes only. In other embodiments, the first and second shapes may be different kinds of shapes.

At least one padding pixel value may be inserted into the second filtering kernel, at 404. For example, referring to FIG. 1, the padding module 134 may insert at least one padding pixel value into the array 138. For example, the padding module 134 may insert low pixel values (e.g., “0”) and high pixel values (e.g., “255”) into the remaining data slots of the array 138.

Based on the second filtering kernel, a median pixel value of the set of pixel values corresponding to the first filtering kernel may be determined, at 406. For example, referring to FIG. 1, the median value computation module 136 may apply the 25-pixel filtering network to the array 138 to determine a median pixel value of the pixels in the filtering kernel 126.

The method 400 of FIG. 4 may remove noise and/or artifacts in an image by selecting outlier pixels in the image and performing median filtering operations to correct (e.g., change) pixel values associated with the outlier pixels. Median filter processing time may be decreased by padding the array to generate a number of pixel values associated with the selected filtering network and removing redundant CEX instructions that compare the padded pixel values. Multiple filtering kernel shapes may be used (as opposed to only rectangular filtering kernel shapes) because the pixel values are inserted into an array, and the sorting network applied to the array is dependent on the array size (corresponding to the size of the filtering kernel) and is independent of the filtering kernel shape.

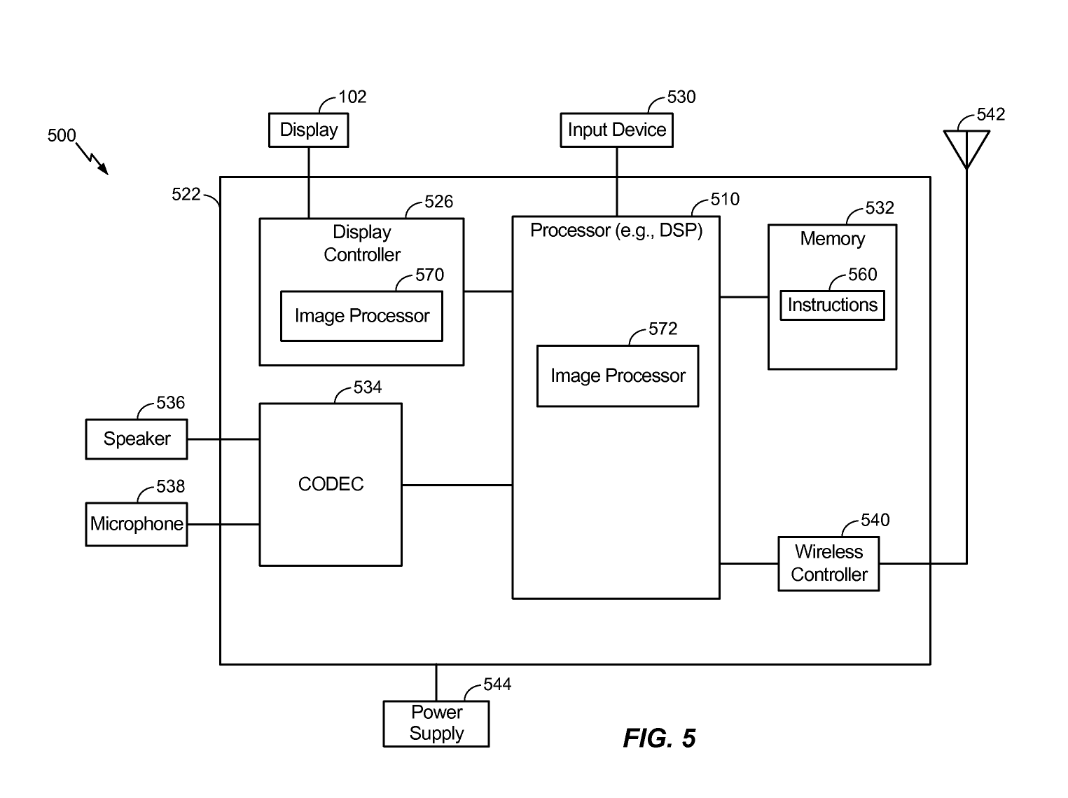

Referring to FIG. 5, a block diagram of a wireless device 500 including components that are operable to determine a median pixel value is shown. The device 500 includes a processor 510, such as a digital signal processor (DSP), coupled to a memory 532.

FIG. 5 also shows a display controller 526 that is coupled to the processor 510 and to the display 102. The display controller 526 may include an image processor 570. In a particular embodiment, the image processor 570 may correspond to the image processor 104 of FIG. 1 and/or the processing system 200 of FIG. 2. The image processor 570 may be configured to perform the method 300 of FIG. 3 and/or at least part of the method 400 of FIG. 4.

A coder/decoder (CODEC) 534 can also be coupled to the processor 510. A speaker 536 and a microphone 538 can be coupled to the CODEC 534. FIG. 5 also indicates that a wireless controller 540 can be coupled to the processor 510 and to an antenna 542.

The memory 532 may be a tangible non-transitory processor-readable storage medium that includes executable instructions 560. The instructions 560 may be executed by a processor, such as the processor 510, to perform the method 300 of FIG. 3 and/or the method 400 of FIG. 4. In a particular embodiment, the processor 510 may include an image processor 572. The image processor 570 may correspond to the image processor 104 of FIG. 1 and/or the processing system 200 of FIG. 2. The image processor 572 may be configured to perform the method 300 of FIG. 3 and/or the method 400 of FIG. 4.

In a particular embodiment, the processor 510, the display controller 526, the memory 532, the CODEC 534, and the wireless controller 540 are included in a system-in-package or system-on-chip device 522. In a particular embodiment, an input device 530 and a power supply 544 are coupled to the system-on-chip device 522. Moreover, in a particular embodiment, as illustrated in FIG. 5, the display 528, the input device 530, the speaker 536, the microphone 538, the antenna 542, and the power supply 544 are external to the system-on-chip device 522. However, each of the display 528, the input device 530, the speaker 536, the microphone 538, the antenna 542, and the power supply 544 can be coupled to a component of the system-on-chip device 522, such as an interface or a controller.

In conjunction with the described embodiments, a first apparatus includes means for selecting a filtering network from a plurality of available filtering networks. For example, the means for selecting the filtering network may include the image processor 104 of FIG. 1, the network selection module 130 of FIG. 1, the processing system 200 of FIG. 2, the network selection module 230 of FIG. 2, the database 232 of FIG. 2, the display controller 526 of FIG. 5, the image processor 570 of FIG. 5, the processor 510 programmed to execute the instructions 560 of FIG. 5, the image processor 570 of FIG. 5, one or more other devices, circuits, modules, or instructions to select the filtering network, or any combination thereof.

The first apparatus may also include means for inserting a set of pixel values into an array. For example, the means for inserting the set of pixel values into the array may include the image processor 104 of FIG. 1, the network selection module 130 of FIG. 1, the array 138 of FIG. 1, the processing system 200 of FIG. 2, the network selection module 230 of FIG. 2, the first channel median filtering module 202 of FIG. 2, the second channel median filtering module 204 of FIG. 2, the third channel median filtering module 206 of FIG. 2, the display controller 526 of FIG. 5, the image processor 570 of FIG. 5, the processor 510 programmed to execute the instructions 560 of FIG. 5, the image processor 570 of FIG. 5, one or more other devices, circuits, modules, or instructions to insert the set of pixel values into the array, or any combination thereof.

The first apparatus may also include means for inserting at least one padding pixel value into the array. For example, the means for inserting the at least one padding pixel value into the array may include the image processor 104 of FIG. 1, the padding module 134 of FIG. 1, the array 138 of FIG. 1, the processing system 200 of FIG. 2, the first channel median filtering module 202 of FIG. 2, the second channel median filtering module 204 of FIG. 2, the third channel median filtering module 206 of FIG. 2, the first padding module 242 of FIG. 2, the second padding module 244 of FIG. 2, the third padding module 246 of FIG. 2, the display controller 526 of FIG. 5, the image processor 570 of FIG. 5, the processor 510 programmed to execute the instructions 560 of FIG. 5, the image processor 570 of FIG. 5, one or more other devices, circuits, modules, or instructions to insert the at least one padding pixel value into the array, or any combination thereof.

The first apparatus may also include means for applying the selected filtering network to the array to determine a median pixel value of the set of pixel values. For example, the means for applying the selected filtering network to the array may include the image processor 104 of FIG. 1, the array 138 of FIG. 1, the median value computation module 136 of FIG. 1, the processing system 200 of FIG. 2, the first channel median filtering module 202 of FIG. 2, the second channel median filtering module 204 of FIG. 2, the third channel median filtering module 206 of FIG. 2, the first median value computation module 252 of FIG. 2, the second median value computation module 254 of FIG. 2, the third median value computation module 256 of FIG. 2, the display controller 526 of FIG. 5, the image processor 570 of FIG. 5, the processor 510 programmed to execute the instructions 560 of FIG. 5, the image processor 570 of FIG. 5, one or more other devices, circuits, modules, or instructions to apply the selected filtering network to the array, or any combination thereof.

In conjunction with the described embodiments, a second apparatus includes means for inserting a set of pixel values corresponding to a first filtering kernel having a first shape into a second filtering kernel having a second shape. For example, the means for inserting the set of pixel values into the second filtering kernel may include the image processor 104 of FIG. 1, the network selection module 130 of FIG. 1, the database 132 of FIG. 1, the processing system 200 of FIG. 2, the network selection module 230 of FIG. 2, the database 232 of FIG. 2, the display controller 526 of FIG. 5, the image processor 570 of FIG. 5, the processor 510 programmed to execute the instructions 560 of FIG. 5, the image processor 570 of FIG. 5, one or more other devices, circuits, modules, or instructions to select the filtering network, or any combination thereof.

The second apparatus may also include means for inserting at least one padding pixel value into the second filtering kernel. For example, the means for inserting the at least one padding pixel value into the second filtering kernel may include the image processor 104 of FIG. 1, the padding module 134 of FIG. 1, the array 138 of FIG. 1, the processing system 200 of FIG. 2, the first channel median filtering module 202 of FIG. 2, the second channel median filtering module 204 of FIG. 2, the third channel median filtering module 206 of FIG. 2, the first padding module 242 of FIG. 2, the second padding module 244 of FIG. 2, the third padding module 246 of FIG. 2, the display controller 526 of FIG. 5, the image processor 570 of FIG. 5, the processor 510 programmed to execute the instructions 560 of FIG. 5, the image processor 570 of FIG. 5, one or more other devices, circuits, modules, or instructions to insert the at least one padding pixel value into the second filtering kernel, or any combination thereof.

The second apparatus may also include means for determining, based on the second filtering kernel, a median pixel value of the set of pixel values corresponding to the first filtering kernel. For example, the means for determining the median pixel value may include the image processor 104 of FIG. 1, the array 138 of FIG. 1, the median value computation module 136 of FIG. 1, the processing system 200 of FIG. 2, the first channel median filtering module 202 of FIG. 2, the second channel median filtering module 204 of FIG. 2, the third channel median filtering module 206 of FIG. 2, the first median value computation module 252 of FIG. 2, the second median value computation module 254 of FIG. 2, the third median value computation module 256 of FIG. 2, the display controller 526 of FIG. 5, the image processor 570 of FIG. 5, the processor 510 programmed to execute the instructions 560 of FIG. 5, the image processor 570 of FIG. 5, one or more other devices, circuits, modules, or instructions to determine the median pixel value, or any combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
selecting, at an image processor, a filtering network from a plurality of available filtering networks;
inserting a set of pixel values into an array;
inserting at least one padding pixel value into the array; and
applying the selected filtering network to the array to determine a median pixel value of the set of pixel values.

2. The method of claim 1, further comprising changing a particular pixel value in the set of pixel values to the median pixel value.

3. The method of claim 2, wherein each pixel value in the set of pixel values represents a color value or a hue value of a corresponding pixel in an image, and wherein the particular pixel value corresponds to an outlier pixel in the portion of the image.

4. The method of claim 1, wherein applying the selected filtering network is part of a median filtering operation to reduce noise in the image, to remove artifacts in the image, to enhance a computer vision application associated with the image, or any combination thereof.

5. The method of claim 4, wherein the noise corresponds to spot noise, chroma noise, or low light noise.

6. The method of claim 4, wherein the artifacts correspond to a line in the image or text in the image.

7. The method of claim 1, wherein the selected filtering network is configured to determine a median for a particular number of pixel values using a particular algorithm, and wherein each of the remaining filtering networks from the plurality of available filtering networks is configured to determine a median for a different number of pixel values using the particular algorithm.

8. The method of claim 7, wherein the particular algorithm corresponds to a compare and exchange (CEX) median filtering algorithm.

9. The method of claim 7, further comprising removing instructions of the particular algorithm that compare a first padding pixel value of the at least one padding pixel value in the array to a second padding pixel value of the at least one padding pixel value in the array.

10. The method of claim 7, wherein the set of pixel values includes a number of pixel values that is between the particular number of pixel values and a next lower number of pixel values associated with one of the remaining filtering networks.

11. The method of claim 1, wherein the at least one padding pixel value does not change the median pixel value of the array.

12. The method of claim 1, further comprising:
inserting a second set of pixel values into a second array, wherein at least one pixel value of the set of pixel values and at least one pixel value of the second set of pixel values represents a common pixel;
inserting at least one padding pixel value into the second array; and
applying the selected filtering network to the second array to determine a second median pixel value of the second set of pixel values.

13. The method of claim 12, wherein the median pixel value of the set of pixel values and the second median pixel value of the second set of pixel values are determined in parallel.

14. The method of claim 12, wherein each pixel value in the set of pixel values corresponds to a value associated with a first channel, and wherein each pixel value in the second set of pixel values corresponds to a value associated with a second channel.

15. The method of claim 14, wherein the first channel is associated with red-difference chroma values, and wherein the second channel is associated with green-difference chroma values or blue-difference chroma values.

16. An apparatus comprising:
a memory; and
an image processor coupled to the memory, wherein the image processor is configured to:
select a filtering network from a plurality of available filtering networks;
insert a set of pixel values into an array;
insert at least one padding pixel value into the array; and
apply the selected filtering network to the array to determine a median pixel value of the set of pixel values.

17. The apparatus of claim 16, wherein the image processor is further configured to change a particular pixel value in the set of pixel values to the median pixel value.

18. A method comprising:
inserting, at an image processor, a set of pixel values corresponding to a first filtering kernel having a first shape into a second filtering kernel having a second shape;
inserting at least one padding pixel value into the second filtering kernel; and
determining, based on the second filtering kernel, a median pixel value of the set of pixel values corresponding to the first filtering kernel.

19. The method of claim 18, wherein the second filtering kernel is configured to determine a median pixel value of a particular number of pixels.

20. The method of claim 19, wherein the second filtering kernel corresponds to a compare and exchange (CEX) median filtering algorithm.
